(19) United States
(12) Patent Application Publication
(10) Pub. No.: US 2026/0245225 A1
(43) Pub. Date: Aug. 20, 2026

(54) MACHINE VISION-BASED METHOD FOR ESTIMATING INNER WALL DEPTH OF FACILITY-BASED CRAB AQUACULTURE CAGE

(71) Applicant: China Agricultural University, Beijing (CN)

(72) Inventors: Kaibin Zong, Beijing (CN); Yuan Gao, Beijing (CN); Jialiang Guo, Beijing (CN); Daoliang Li, Beijing (CN)

(73) Assignee: China Agricultural University, Beijing (CN)

(21) Appl. No.: 19/535,424

(22) Filed: Feb. 10, 2026

(30) Foreign Application Priority Data
Feb. 18, 2025 (CN) 202510173701.3

(51) Int. Cl. G06T 7/50; A01K 29/00; A01K 61/59; G06T 7/00; G06T 7/60; G06V 10/70; G06V 20/05; G06V 20/52; G06V 40/10

(52) U.S. Cl. CPC G06T 7/50; A01K 29/005; A01K 61/59; G06T 7/0012; G06T 7/60; G06V 10/70; G06V 20/05; G06V 20/52; G06V 40/10; G06T 2207/10028; G06T 2207/20081; G06T 2207/30232

(57) ABSTRACT

Provided is a machine vision-based method for estimating an inner wall depth of a facility-based crab aquaculture cage, which relates to the technical field of facility-based aquaculture. A monocular depth estimation model is combined with geometric structural constraints of the crab aquaculture cage. An object depth in an image is preliminarily predicted through the monocular depth estimation model. Based on this, and relying on prior information such as a structure and physical dimensions of the crab aquaculture cage, depth values of points on an inner wall of the crab aquaculture cage in a camera coordinate system are recovered by constructing an analytical geometric calculation model. This can significantly alleviate scale drift and bias problems existing in an existing monocular depth estimation method, thereby improving accuracy of depth estimation results, without relying on a deep learning technology and constructing and annotating large-scale training datasets.

### CROSS REFERENCE TO RELATED APPLICATION

This patent application claims the benefit and priority of Chinese Patent Application No. 202510173701.3, filed with the China National Intellectual Property Administration on Feb. 18, 2025, the disclosure of which is incorporated by reference herein in its entirety as part of the present application.

### TECHNICAL FIELD

This application relates to the technical field of facility-based aquaculture, and in particular, to a machine vision-based method for estimating an inner wall depth of a facility-based crab aquaculture cage.

### BACKGROUND

Facility-based aquaculture is a critical direction for future development of smart agriculture. To achieve accurate monitoring of growth status of cultured subjects, it is necessary to recover real distances of objects within a scene in a camera coordinate system based on image information. An existing monocular vision-based depth estimation model often exhibits varying degrees of scale drift and bias in outputs across different regions of an image. This leads to a significant difference between a predicted depth and a true depth, making it difficult to meet requirements for growth status monitoring. In addition, image depth estimation based on deep learning typically requires acquisition of a large amount of depth image data for model training or fine-tuning, incurring substantial costs for data acquisition and training.

### SUMMARY

An objective of this application is to provide a machine vision-based method for estimating an inner wall depth of a facility-based crab aquaculture cage, to improve accuracy of estimating the inner wall depth of the facility-based crab aquaculture cage.

To achieve the above objective, this application provides the following technical solutions.

According to a first aspect, this application provides a machine vision-based method for estimating an inner wall depth of a facility-based crab aquaculture cage, including the following steps:
acquiring a top-view image of the crab aquaculture cage containing crabs and being full of transparent water;
inputting the top-view image into a monocular depth estimation model, and outputting a depth estimation value of each pixel in the top-view image;
converting pixel coordinates of each pixel of remaining pixels in the top-view image into three-dimensional point cloud data of each pixel based on the depth estimation value of each pixel, where the three-dimensional point cloud data of each pixel are three-dimensional coordinates of each pixel in a camera coordinate system;
calculating a normal vector of each pixel based on the three-dimensional point cloud data of each pixel;
determining a plane of the crab aquaculture cage to which each pixel belongs, based on the normal vector of each pixel, where the crab aquaculture cage includes five planes that are a front plane, a back plane, a left plane, a right plane, and a bottom plane of the crab aquaculture cage; and
respectively determining inner wall depths at different pixels on each of the five planes based on pixel coordinates of each pixel on each of the five planes and physical dimensions of the crab aquaculture cage;
inputting the top-view image into a deep learning based object detection algorithm to determine crab pixels corresponding to the crabs;
determining, based on the crab pixels, an inner wall depth of a crab pixel cluster comprising a plurality of crab pixels gathering together, through calculating an average of inner wall depths of the crab pixels gathering together on each of the front plane, the back plane, the left plane and the right plane of the crab aquaculture cage;
determining an average of inner wall depths of pixels of top edge of the crab aquaculture cage, as an inner wall depth of the top edge;
calculating a difference value between the inner wall depth of the crab pixel cluster and the inner wall depth of the top edge; and
in response to a determination that the difference value is less than a predetermined threshold, sending a warning signal indicating an abnormal status of the crabs to an external device.

According to a second aspect, this application provides a machine vision-based method for estimating an inner wall depth of a facility-based crab aquaculture cage, including the following steps:
acquiring a top-view image of the crab aquaculture cage containing crabs and transparent water body;
inputting the top-view image into a monocular depth estimation model, and outputting a depth estimation value of each pixel in the top-view image;
inputting the top-view image into a deep learning based object detection algorithm to determine pixels of a water surface that contact with a front plane, a back plane, a left plane and a right plane of the crab aquaculture cage and excluding other pixels of the transparent water body than the pixels of the water surface that contact with the front plane, the back plane, the left plane and the right plane;
converting pixel coordinates of each pixel of remaining pixels in the top-view image into three-dimensional point cloud data of each pixel based on the depth estimation value of each pixel, wherein the three-dimensional point cloud data of each pixel are three-dimensional coordinates of each pixel in a camera coordinate system;
calculating a normal vector of each pixel based on the three-dimensional point cloud data of each pixel;
determining, based on the normal vector of each pixel, a plane of the crab aquaculture cage to which each pixel belongs, wherein the crab aquaculture cage comprises five planes that are the front plane, the back plane, the left plane, the right plane, and a bottom plane of the crab aquaculture cage;
respectively determining inner wall depths at different pixels on each of the five planes based on pixel coordinates of each pixel on each of the five planes and physical dimensions of the crab aquaculture cage;
inputting the top-view image into the deep learning based object detection algorithm to determine crab pixels corresponding to the crabs;
determining, based on the crab pixels, an inner wall depth of a crab pixel cluster comprising a plurality of crab pixels gathering together, through calculating an average of inner wall depths of the crab pixels gathering together on each of the front plane, the back plane, the left plane and the right plane of the crab aquaculture cage;
determining an average of inner wall depths of the pixels of the water surface that contact with the front plane, the back plane, the left plane and the right plane, as an inner wall depth of a water level line;
calculating a difference value between the inner wall depth of the crab pixel cluster and the inner wall depth of the water level line; and
in response to a determination that the difference value is less than a predetermined threshold, sending a warning signal indicating an abnormal status of the crabs to an external device.

According to specific embodiments provided in this application, this application discloses the following technical effects:
According to the machine vision-based method for estimating an inner wall depth of a facility-based crab aquaculture cage provided in this application, a monocular depth estimation model is combined with geometric structural constraints of the crab aquaculture cage. An object depth in an image is preliminarily predicted through the monocular depth estimation model. Based on this, and relying on prior information such as a structure and physical dimensions of the crab aquaculture cage, depth values of points on an inner wall of the crab aquaculture cage in the camera coordinate system are recovered by constructing an analytical geometric calculation model. This can significantly alleviate scale drift and bias problems existing in an existing monocular depth estimation method, thereby improving accuracy of depth estimation results, without relying on a deep learning technology and constructing and annotating large-scale training datasets.

### BRIEF DESCRIPTION OF THE DRAWINGS

To describe the technical solutions in the embodiments of this application or in the conventional technology more clearly, the following briefly describes the accompanying drawings required for the embodiments. Apparently, the accompanying drawings in the following description show merely some embodiments of this application, and a person of ordinary skill in the art may still derive other accompanying drawings from these accompanying drawings without creative efforts.

FIG. 1 is a schematic diagram of a machine vision-based method for estimating an inner wall depth of a facility-based crab aquaculture cage according to an embodiment of this application;

FIG. 2 is a principle diagram of a machine vision-based method for estimating an inner wall depth of a facility-based crab aquaculture cage according to an embodiment of this application; and

FIG. 3 is a schematic diagram illustrating a camera deployment structure according to an embodiment of this application.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

To make the above objectives, features, and advantages of this application more obvious and easier to understand, this application will be further described in detail with reference to the accompanying drawings and specific implementations.

An existing monocular depth estimation model is typically constructed based on a deep learning method and tends to focus more on leveraging image pixel values and local neighborhood information. However, facility-based three-dimensional aquaculture commonly employs a crab aquaculture cage, which possesses a regular geometric structure. Such structural information has not been effectively utilized in the existing monocular depth estimation model, thus necessitating further improvement and refinement.

According to this application, a monocular depth estimation model is combined with geometric structural constraints of the crab aquaculture cage. An object depth in an image is preliminarily predicted through the monocular depth estimation model. Based on this, and relying on prior information such as structures and physical dimensions of a camera imaging model and the crab aquaculture cage, depth values of points on an inner wall of the crab aquaculture cage in a camera coordinate system are recovered by constructing an analytical geometric calculation model. This can alleviate scale drift and bias problems existing in an existing monocular depth estimation method, thereby improving accuracy of depth estimation results, without relying on a deep learning technology and constructing and annotating large-scale training datasets.

In an example embodiment, a machine vision-based method for estimating an inner wall depth of a facility-based crab aquaculture cage is provided. In this method, depth values of various parts of an inner wall of the crab aquaculture cage in a camera coordinate system can be estimated by combining a relative depth output from a depth estimation model with camera intrinsic parameters and physical dimensions of the crab aquaculture cage. The process specifically includes several stages: image depth estimation and point cloud generation, surface normal vector calculation, segmentation of the inner wall of the crab aquaculture cage image, calculation of an inner wall depth, and the like. This method is suitable for deployment in a practical environment, providing an intelligent analytical tool for facility-based crab aquaculture.

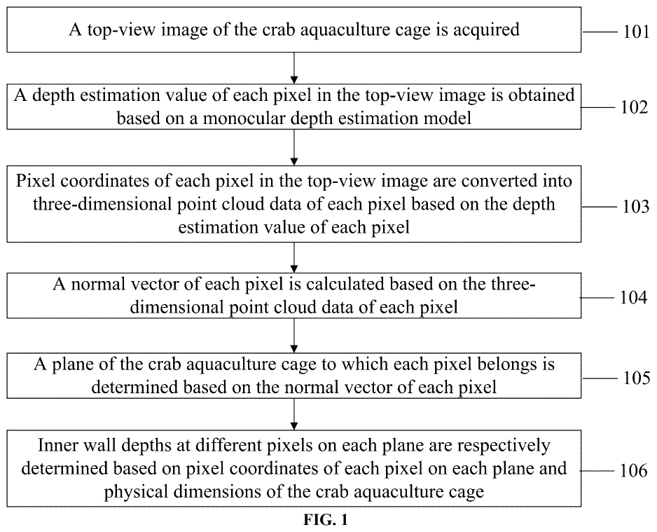

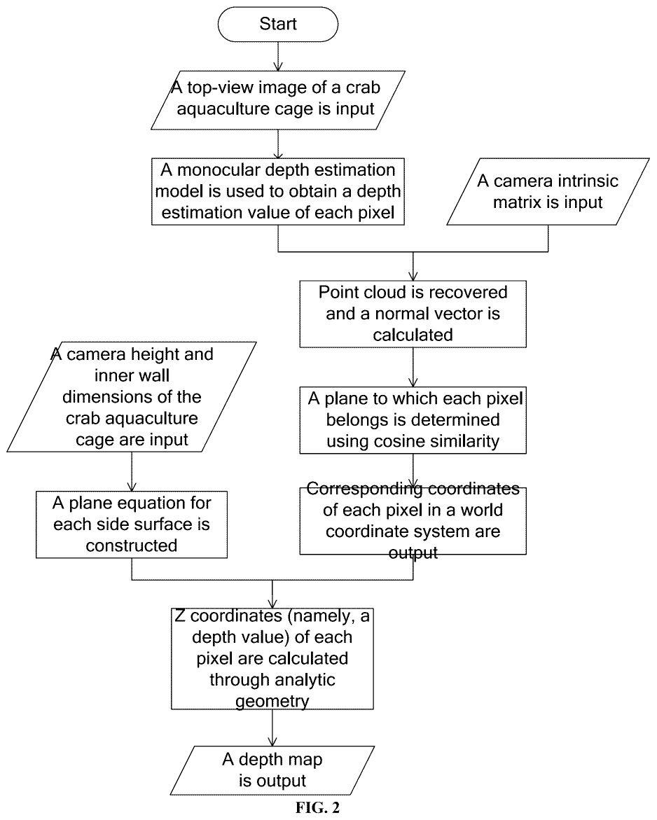

As shown in FIG. 1 and FIG. 2, the machine vision-based method for estimating an inner wall depth of a facility-based crab aquaculture cage provided in this application includes the following steps 101 to 106.

In step 101, a top-view image of the crab aquaculture cage containing crabs and transparent water body is acquired. The crabs crawl against inner walls of the crab aquaculture cage.

In step 102, except for pixels of transparent water body, a depth estimation value of each pixel in the top-view image is obtained based on a monocular depth estimation model.

In step 103, pixel coordinates of each pixel in the top-view image are converted into three-dimensional point cloud data of each pixel based on the depth estimation value of each pixel, where the three-dimensional point cloud data of each pixel are three-dimensional coordinates of each pixel in a camera coordinate system.

In step 104, a normal vector of each pixel is calculated based on the three-dimensional point cloud data of each pixel.

In step 105, a plane of the crab aquaculture cage to which each pixel belongs is determined based on the normal vector of each pixel, where the crab aquaculture cage includes five planes that are a front plane, a back plane, a left plane, a right plane, and a bottom plane of the crab aquaculture cage.

In step 106, inner wall depths at different pixels on each plane are respectively determined based on pixel coordinates of each pixel on each plane and physical dimensions of the crab aquaculture cage.

Implementing the steps 101 to 106 can mitigate problems of scale drift and bias in an existing monocular depth estimation method and improve the accuracy of depth estimation results.

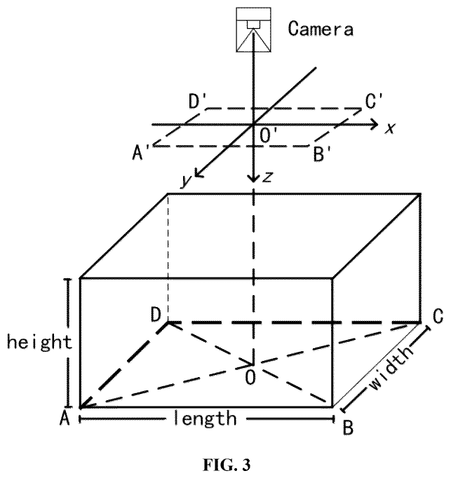

In another example embodiment, in step 101, a regular cuboid crab aquaculture cage is adopted. As shown in FIG. 3 internal physical dimensions (a length, a width, a height) of the crab aquaculture cage are known quantities. A camera is positioned above a center point of the crab aquaculture cage for top-view image shooting. A camera imaging plane A′B′C′D′ is parallel to a bottom plane ABCD of the crab aquaculture cage, and a camera optical center O′ is aligned with a geometric center O of the bottom plane of the crab aquaculture cage. A camera intrinsic matrix K is a known quantity and can be obtained through offline calibration.

In another example embodiment, in step 102, depth estimation is performed by a monocular depth estimation model (for example, Depth Pro) on a top-view image captured by the camera, to obtain a depth estimation value Z of each pixel in the top-view image, namely, z-axis coordinate Z_{c} of the pixel in the camera coordinate system. In another example embodiment, in step 102, the top-view image is input into a deep learning based object detection algorithm (such as YOLO algorithm) to determine pixels of a water surface that contact with a front plane, a back plane, a left plane and a right plane of the crab aquaculture cage and excluding other pixels of the transparent water body than the pixels of the water surface that contact with the front plane, the back plane, the left plane and the right plane.

In another example embodiment, in step 103, based on the depth estimation value Z of the pixel and the camera intrinsic matrix K, pixel coordinates of each pixel in the top-view image are converted into three-dimensional point cloud data of each pixel, forming a three-dimensional description of a field of view of the camera. A conversion formula is as follows:

$${X}_{c} = Z \cdot \frac{u - {u}_{0}}{{f}_{x}} , {Y}_{c} = Z \cdot \frac{v - {v}_{0}}{{f}_{y}} , {Z}_{c} = Z .$$

Herein, (X_{c}, Y_{c}, Z_{c}) are the three-dimensional coordinates of the pixel in the camera coordinate system, namely, three-dimensional point cloud data; X_{c}, Y_{c}, and Z_{c} are respectively x-axis, y-axis, and z-axis coordinates of the pixel in the camera coordinate system; Z is the depth estimation value of the pixel; (u, v) are the pixel coordinates of the pixel in the top-view image; u and v are respectively horizontal and vertical coordinates of the pixel in the top-view image; (u₀, v₀) are coordinates of a camera principal point; u₀ and v₀ are respectively horizontal and vertical coordinates of the camera principal point; and fₓ and f_{y} are respectively focal lengths of the a camera in x-axis and γ-axis directions of the camera coordinate system.

In this application, the pixel coordinates of a pixel are coordinates in an image coordinate system, and the horizontal and vertical coordinates of the pixel are x-axis and γ-axis coordinates in the image coordinate system.

In another example embodiment, based on the three-dimensional point cloud data, a normal vector corresponding to each point (namely, each pixel in the top-view image) on the inner wall of the crab aquaculture cage is calculated. Let a neighborhood search radius be r and a maximum number of nearest neighbors be max_nn. Under the constraints of max_nn and the search radius r, all nearest neighbor points centered on a pixel p are found. A local plane can be fitted based on each pixel p and its neighboring points, and a normal vector of the local plane is a normal vector of the pixel p. In an embodiment of this application, steps 201 to 203 described below may replace step 104 mentioned above.

In step 201, a plurality of pixels within a neighborhood range of the pixel p are acquired.

In step 202, plane fitting is performed on the pixel p and the plurality of pixels within the neighborhood range of the pixel p to obtain a local plane at the pixel p.

In step 203, a normal vector of the local plane is calculated as a normal vector of the pixel p.

In the solving process, a centroid of the local plane needs to be firstly determined:

$$c = \frac{1}{N} {\sum }_{i = 1}^{N} {p}_{i} .$$

c is the centroid of the local plane, N is a number of pixels on the local plane, pᵢ is three-dimensional point cloud data of an i^{th} pixel on the local plane.

Then, the local plane is de-centered to obtain de-centered three-dimensional point cloud data of each pixel on the local plane: qᵢ=pᵢ−c.

qᵢ is de-centered three-dimensional point cloud data of the i^{th} pixel point on the local plane.

Then, a covariance matrix C:

$$C = \frac{1}{N} {\sum }_{i = 1}^{N} {q}_{i} {q}_{i}^{T}$$

is constructed using the de-centered three-dimensional point cloud data of each pixel on the local plane, where the superscript T indicates transpose.

Eigenvalue decomposition is performed on the covariance matrix C: C=VΛV^{T}.

Λ=diag(λ₁, λ₂, λ₃) is an eigenvalue matrix of the covariance matrix C; λ₁, λ₂, and λ₃ are all eigenvalues of the covariance matrix C; V=[v₁, v₂, v₃] is an eigenvector matrix of the covariance matrix C; and v₁, v₂, and v₃ are all eigenvalues of the covariance matrix C. An eigenvalue corresponding to a smallest eigenvalue λₘᵢₙ is a normal vector vₘᵢₙ. The normal vector vₘᵢₙ is normalized to obtain a normalized normal vector n, where the normalization formula is as follows:

$$n = \frac{{v}_{min}}{‖ {v}_{min} ‖} .$$

In another example embodiment, in step 105, each plane of the crab aquaculture cage is segmented by analyzing the normal vector. With the three-dimensional point cloud using an optical center of the camera as an observation point, under a condition that the camera imaging plane is parallel to the bottom plane of the crab aquaculture cage and the optical center of the camera is aligned with a geometric center of bottom plane of the crab aquaculture cage, it can be assumed that normal vectors of the five planes: the front plane, the back plane, the left plane, the right plane, and the bottom plane are respectively (0,1,0), (0,−1,0), (−1,0,0), (1,0,0), and (0,0,1), cosine similarity between the normal vector of each pixel and the normal vectors of the five planes is calculated.

$${CosineSimilarity}_{p , s} = cos < {n}_{p} , {n}_{s} >= \frac{{n}_{p} \cdot {n}_{s}}{‖ {n}_{p} ‖ \cdot ‖ {n}_{s} ‖} .$$

Cos i neSimilarity_{p,s} is similarity between the normal vector of the pixel p and a normal vector of an s^{th} plane of the crab aquaculture cage; nₚ is the normal vector of the pixel p; and nₛ is the normal vector of the s^{th} plane of the crab aquaculture cage.

In another example embodiment, steps 301 to 304 described below may replace step 106 mentioned above.

In step 301, plane equations for side surfaces of the crab aquaculture cage are constructed based on the physical dimensions of the crab aquaculture cage, where the side surfaces of the crab aquaculture cage includes the front plane, the back plane, the left plane, and the right plane.

In step 302, inverse projection transformation is performed on each pixel to obtain three-dimensional coordinates of each pixel in a world coordinate system.

In step 303, the three-dimensional coordinates (x_{w}, y_{w}, z_{w}) of each pixel in the world coordinate system are combined with a plane equation of a side surface to which the pixel belongs, to calculate the inner wall depths at different pixels on the side surfaces, where x_{w}, y_{w}, and z_{w} are respectively x-axis, y-axis, and z-axis coordinates of the pixel in the world coordinate system.

Based on the camera imaging model, there is a correspondence between points in the image coordinate system and points in the world coordinate system:

$${Z}_{c} [ \begin{matrix}u \\ v \\ 1\end{matrix} ] = [ \begin{matrix}K & 0\end{matrix} ] [ \begin{matrix}R & T \\ 0 & 1\end{matrix} ] [ \begin{matrix}w \\ {y}_{w} \\ {z}_{w} \\ 1\end{matrix} ] .$$

That is,

$$[ \begin{matrix}{x}_{w} \\ {y}_{w} \\ {z}_{w}\end{matrix} ] = {R}^{- 1} ( {K}^{- 1} [ \begin{matrix}u \\ v \\ 1\end{matrix} ] {Z}_{c} - T ) .$$

Herein, (u, v) are pixel coordinates of the pixel in the top-view image; Z_{c} are z-axis coordinates of the pixel in the camera coordinate system, Z_{c}=Z; R and T are a rotation matrix and a translation vector of the camera extrinsic parameter matrix, and respectively indicate rotation and translation parameters between the camera coordinate system and the world coordinate system; to simplify calculations, it is assumed that in the embodiments of this application that the world coordinate system coincides with the camera coordinate system (both are O′−xyz). Therefore,

$$R = ( \begin{matrix}1 & 0 & 0 \\ 0 & 1 & 0 \\ 0 & 0 & 1\end{matrix} ) , and T = [ \begin{matrix}0 \\ 0 \\ 0\end{matrix} ] .$$

K is the camera intrinsic matrix, which can be obtained through camera calibration, and is defined as

$$K = ( \begin{matrix}x & α & {u}_{0} \\ 0 & f & {v}_{0} \\ 0 & 0 & 1\end{matrix} )$$

Let R⁻¹K⁻¹=A(aₘₙ), -R⁻¹T=B(bₘ), m=1,2,3, n=1,2,3, m, and n respectively indicate horizontal and vertical position indices of elements in A; a₁₁, a₁₂, a₁₃, and b₁ are x-axis coordinate transformation coefficients; a₂₁, a₂₂, a₂₃, and b₂ are y-axis coordinate transformation coefficients; a₃₁, a₃₂, a₃₃, and b₃ are z-axis coordinate transformation coefficients. In this case, a coordinate transformation equation for (x_{w}, y_{w}, z_{w}) corresponding to each pixel (u, v) in the top-view image is as follows:

$$\{ \begin{matrix}{x}_{w} = ( {a}_{11} u + {a}_{12} v + {a}_{13} ) {z}_{c} + {b}_{1} \\ {y}_{w} = ( {a}_{21} u + {a}_{22} v + {a}_{23} ) {z}_{c} + {b}_{2} \\ {z}_{w} = ( {a}_{31} u + {a}_{32} v + {a}_{33} ) {z}_{c} + {b}_{3}\end{matrix} .$$

Herein, (x_{w}, y_{w}, z_{w}) are three-dimensional coordinates of the pixel in the world coordinate system. The pixel is located on a line connecting the optical center of the camera and the pixel (u, v) in the top-view image. As an inner length (length) and an inner width (width) of the crab aquaculture cage are known, the four inner walls (front, back, left, and right inner walls) can be regarded as four known planes in the world coordinate system, with equations are as follows:

$${P}_{left} : {x}_{w} = - \frac{length}{2} ;$$

$${P}_{right} : {x}_{w} = \frac{length}{2} ;$$

$${P}_{front} : {y}_{w} = \frac{width}{2} ; and$$

$${P}_{back} : {y}_{w} = - \frac{width}{2} .$$

The four plane equations are respectively combined with the coordinate transformation equation to obtain coordinates z_{w} of intersection points. In this case, the transformed points in the world coordinate system are just located on the inner wall planes of the crab aquaculture cage, and the obtained value z_{w} is a true depth of the corresponding point on the inner walls in the camera coordinate system. The four combined equations are as follows:

$${P}_{front} : ( {a}_{21} {u}_{front} + {a}_{22} {v}_{front} + {a}_{23} ) Z ( {u}_{front} , {v}_{front} ) + {b}_{2} = \frac{width}{2} ;$$

$${P}_{back} : ( {a}_{21} {u}_{back} + {a}_{22} {v}_{back} + {a}_{23} ) Z ( {u}_{back} , {v}_{back} ) + {b}_{2} = - \frac{width}{2} ;$$

$${P}_{left} : ( {a}_{11} {u}_{left} + {a}_{12} {v}_{left} + {a}_{13} ) Z ( {u}_{left} , {v}_{left} ) + {b}_{1} = - \frac{length}{2} ; and$$

$${P}_{right} : ( {a}_{11} {u}_{right} + {a}_{12} {v}_{right} + {a}_{13} ) Z ( {u}_{right} , {v}_{right} ) + {b}_{1} = \frac{length}{2} .$$

P_{front}, P_{back}, P_{left}, and P_{right} are respectively the front plane, the back plane, the left plane, the right plane; u_{front} and v_{front} are respectively horizontal and vertical coordinates of the pixel on the front plane; u_{back} and v_{back} are respectively horizontal and vertical coordinates of the pixel on the back plane; u_{left} and v_{left} are respectively horizontal and vertical coordinates of the pixel on the left plane; u_{right} and v_{right} are respectively horizontal and vertical coordinates of the pixel on the right plane; Z(u_{front}, v_{front}) is a depth estimation value at the pixel coordinates (u_{front}, v_{front}) of the pixel on the front plane; Z(u_{back}, v_{back}) is a depth estimation value at the pixel coordinates (u_{back}, v_{back}) of the pixel on the back plane; Z(u_{left}, v_{left}) is a depth estimation value at the pixel coordinates (u_{left}, v_{left}) of the pixel on the left plane; Z(u_{right}, v_{right}) is a depth estimation value at the pixel coordinates (u_{right}, v_{right}) of the pixel on the right plane; width is an inner width of the crab aquaculture cage; and length is an inner length of the crab aquaculture cage.

Based on the plane equations of the side surfaces of the crab aquaculture cage, the formula for calculating the true depth corresponding to each pixel on each side surface is as follows:

$${depth}_{left} ( {u}_{left} , {v}_{left} ) = \frac{- \frac{length}{2} - {b}_{1}}{{a}_{11} {u}_{left} + {a}_{12} {v}_{left} + {a}_{13}} ;$$

$${depth}_{right} ( {u}_{right} , {v}_{right} ) = \frac{\frac{length}{2} - {b}_{1}}{{a}_{11} {u}_{right} + {a}_{12} {v}_{right} + {a}_{13}} ;$$

$${depth}_{front} ( {u}_{front} , {v}_{front} ) = \frac{\frac{width}{2} - {b}_{2}}{{a}_{21} {u}_{front} + {a}_{22} {v}_{front} + {a}_{23}} ; and$$

$${depth}_{back} ( {u}_{back} , {v}_{back} ) = \frac{- \frac{width}{2} - {b}_{2}}{{a}_{21} {u}_{back} + {a}_{22} {v}_{back} + {a}_{23}} .$$

Herein, depth_{left} (u_{left}, v_{left}) is the inner wall depth at the pixel coordinates (u_{left}, v_{left}) on the left plane; depth_{right}(u_{right}, v_{right}) is the inner wall depth at the pixel coordinates (u_{right}, v_{right}) on the right plane; depth_{front}(u_{front}, v_{front}) is the inner wall depth at the pixel coordinates (u_{front}, v_{front}) on the front plane; and depth_{back}(u_{back}, v_{back}) is the inner wall depth at the pixel coordinates (u_{back}, back) on the back plane.

In step 304, an inner wall depth at the bottom plane of the crab aquaculture cage is determined based on a distance between the bottom plane of the crab aquaculture cage and the camera imaging plane as follows: pth_{bottom}=height, where depth_{bottom} is the inner wall depth of the bottom plane of the crab aquaculture cage, and height is the distance between the bottom plane of the crab aquaculture cage and the camera imaging plane.

Based on results of an existing monocular depth estimation model, camera imaging parameters (intrinsic/extrinsic) are combined with geometric structure information of the crab aquaculture cage in this application through steps including three-dimensional point cloud generation, surface normal vector calculation, inner wall segmentation of the crab aquaculture cage, inner wall depth calculation, and the like. A spatial analytical geometry model is constructed to effectively recover the inner wall depth of the crab aquaculture cage, thereby significantly eliminating scale drift and scale bias in existing monocular depth estimation results, and improving accuracy of monocular depth estimation in facility-based aquaculture scenarios.

In some embodiments, the method described above can be used to monitor whether there is an abnormal status of the aquaculture objects. Crab hypoxia is a common abnormal status in the aquaculture, especially during the high temperature season, the dissolved oxygen in the water decreases, which can easily lead to crab death. In water with no supplemental oxygen, crabs usually die within about 4 hours due to hypoxia. Oxygen deficiency in the water can cause crabs to exhibit abnormal behaviors, such as migrating extensively along the inner walls of the aquaculture cage to shallower areas, and even climbing out of the water surface. Based on this, it is possible to determine whether there is an abnormality in the crabs' status (i.e. hypoxia) by determining the inner wall depth of a location where the crabs gather together.

In some implementations, the aquaculture cage can be idealized as being full of transparent water. In this case, the state of the crab can be determined based on the distance from the crab to the top edge of the crab aquaculture cage. In some implementations, a deep learning based object detection algorithm (such as YOLO algorithm) can be used to identify the pixels corresponding to the crab and pixels of the crab aquaculture cage from the acquired top-view image. Specifically, the top-view image is input into the deep learning based object detection algorithm (such as YOLO algorithm) to determine crab pixels corresponding to the crabs. Based on the crab pixels, an inner wall depth of a crab pixel cluster comprising a plurality of crab pixels gathering together is determined, through calculating an average of inner wall depths of the crab pixels gathering together on each of the front plane, the back plane, the left plane and the right plane of the crab aquaculture cage. An average of inner wall depths of pixels of top edge of the crab aquaculture cage is determined as an inner wall depth of the top edge. A difference value between the inner wall depth of the crab pixel cluster and the inner wall depth of the top edge may be calculated. When the difference value is greater than the predetermined threshold, it indicates that there is no abnormality in crab activity and monitoring continues. When the difference value is less than the predetermined threshold, it indicates that the crab is migrating upwards due to hypoxia. And in response to a determination that the difference value is less than a predetermined threshold, a warning signal indicating an abnormal status of the crabs can be sent to an external device such as a smartphone, a laptop, and/or a personal computer (PC).

In some implementations, it cannot be idealized to assume that the aquaculture cage is full of transparent water. In this case, the state of the crab can be determined based on the distance from the crab to the water surface (i.e. the water level line). Specifically, the top-view image is input into the deep learning based object detection algorithm to determine crab pixels corresponding to the crabs. Based on the crab pixels, an inner wall depth of a crab pixel cluster comprising a plurality of crab pixels gathering together is determined through calculating an average of inner wall depths of the crab pixels gathering together on each of the front plane, the back plane, the left plane and the right plane of the crab aquaculture cage. An average of inner wall depths of the pixels of the water surface that contact with the front plane, the back plane, the left plane and the right plane is determined as an inner wall depth of a water level line. A difference value between the inner wall depth of the crab pixel cluster and the inner wall depth of the water level line can be calculate. And in response to a determination that the difference value is less than a predetermined threshold, a warning signal indicating an abnormal status of the crabs can be sent to an external device.

In addition, in response to the determination that the deference is less than a predetermined threshold (i.e., hypoxia occurs), the processor may activate an aerator to increase the dissolved oxygen in the water.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing embodiments is used to help illustrate the method of this application and the core principles thereof. In addition, those of ordinary skill in the art can make various modifications in terms of specific implementations and scope of application in accordance with the teachings of this application. In conclusion, the content of the specification shall not be construed as a limitation to this application.

What is claimed is:

1. A machine vision-based method for estimating an inner wall depth of a facility-based crab aquaculture cage, comprising:
acquiring a top-view image of the crab aquaculture cage containing crabs and being full of transparent water;
inputting the top-view image into a monocular depth estimation model, and outputting a depth estimation value of each pixel in the top-view image;
excluding pixels of the transparent water body;
converting pixel coordinates of each pixel of remaining pixels in the top-view image into three-dimensional point cloud data of each pixel based on the depth estimation value of each pixel, wherein the three-dimensional point cloud data of each pixel are three-dimensional coordinates of each pixel in a camera coordinate system;
calculating a normal vector of each pixel based on the three-dimensional point cloud data of each pixel;
determining, based on the normal vector of each pixel, a plane of the crab aquaculture cage to which each pixel belongs, wherein the crab aquaculture cage comprises five planes that are a front plane, a back plane, a left plane, a right plane, and a bottom plane of the crab aquaculture cage;
respectively determining inner wall depths at different pixels on each of the five planes based on pixel coordinates of each pixel on each of the five planes and physical dimensions of the crab aquaculture cage;
inputting the top-view image into a deep learning based object detection algorithm to determine crab pixels corresponding to the crabs;
determining, based on the crab pixels, an inner wall depth of a crab pixel cluster comprising a plurality of crab pixels gathering together, through calculating an average of inner wall depths of the crab pixels gathering together on each of the front plane, the back plane, the left plane and the right plane of the crab aquaculture cage;
determining an average of inner wall depths of pixels of top edge of the crab aquaculture cage, as an inner wall depth of the top edge;
calculating a difference value between the inner wall depth of the crab pixel cluster and the inner wall depth of the top edge; and
in response to a determination that the difference value is less than a predetermined threshold, sending a warning signal indicating an abnormal status of the crabs to an external device.

2. The machine vision-based method for estimating an inner wall depth of a facility-based crab aquaculture cage according to claim 1, wherein a formula for converting the pixel coordinates of each pixel in the top-view image into the three-dimensional point cloud data of each pixel based on the depth estimation value of each pixel is as follows:
$${X}_{c} = Z \cdot \frac{u - {u}_{0}}{{f}_{x}} ;$$
$${Y}_{c} = Z \cdot \frac{v - {v}_{0}}{{f}_{y}} ;$$
$${Z}_{c} = Z ;$$
wherein, (X_{c}, Y_{c}, Z_{c}) are the three-dimensional coordinates of the pixel in the camera coordinate system, X_{c}, Y_{c}, and Z_{c} are respectively x-axis, y-axis, and z-axis coordinates of the pixel in the camera coordinate system, Z is the depth estimation value of the pixel, (u, v) are the pixel coordinates of the pixel in the top-view image, u and v are respectively horizontal and vertical coordinates of the pixel in the top-view image, (u₀, v₀) are coordinates of a camera principal point, u₀ and v₀ are respectively horizontal and vertical coordinates of the camera principal point, fₓ and f_{y} are respectively focal lengths of a camera in x-axis and γ-axis directions of the camera coordinate system.

3. The machine vision-based method for estimating an inner wall depth of a facility-based crab aquaculture cage according to claim 1, wherein calculating the normal vector of each pixel based on the three-dimensional point cloud data of each pixel comprises:
acquiring a plurality of pixels within a neighborhood range of a pixel p;
performing plane fitting on the pixel p and the plurality of pixels within the neighborhood range of the pixel p to obtain a local plane at the pixel p; and
calculating a normal vector of the local plane as a normal vector of the pixel p.

4. The machine vision-based method for estimating an inner wall depth of a facility-based crab aquaculture cage according to claim 3, wherein calculating the normal vector of the local plane as the normal vector of the pixel p comprises:
calculating a centroid of the local plane using a following formula:
$$c = \frac{1}{N} {\sum }_{i = 1}^{N} {p}_{i}$$
wherein, c is the centroid of the local plane, N is a number of pixels on the local plane, pᵢ is three-dimensional point cloud data of an i^{th} pixel on the local plane;
based on the centroid of the local plane, performing de-centering on the three-dimensional point cloud data of each pixel on the local plane using a following formula to obtain de-centered three-dimensional point cloud data of each pixel on the local plane:
$${q}_{i} = {p}_{i} - c$$
wherein, qᵢ is de-centered three-dimensional point cloud data of the i^{th} pixel on the local plane;
constructing a covariance matrix C:
$$C = \frac{1}{N} {\sum }_{i = 1}^{N} {q}_{i} {q}_{i}^{T}$$
using the de-centered three-dimensional point cloud data of each pixel on the local plane, wherein the superscript T indicates transpose;
performing eigenvalue decomposition on the covariance matrix to obtain eigenvalues of the covariance matrix, and an eigenvector corresponding to each of the eigenvalues; and
determining an eigenvector corresponding to a smallest eigenvalue as the normal vector of the local plane, namely, the normal vector of the pixel p.

5. The machine vision-based method for estimating an inner wall depth of a facility-based crab aquaculture cage according to claim 3, wherein after calculating the normal vector of the local plane as the normal vector of the pixel p, the machine vision-based method further comprises:
normalizing the normal vector of the pixel p.

6. The machine vision-based method for estimating an inner wall depth of a facility-based crab aquaculture cage according to claim 1, wherein determining, based on the normal vector of each pixel, the plane of the crab aquaculture cage to which each pixel belongs comprises:
respectively calculating similarity between the normal vector of the pixel p and a normal vector of each of the five planes of the crab aquaculture cage using a following formula:
$$Cos i {neSimilarity}_{p , s} = cos < {n}_{p} , {n}_{s} > = \frac{{n}_{p} \cdot {n}_{s}}{‖ {n}_{p} ‖ \cdot ‖ {n}_{s} ‖} ,$$
Cos i neSimilarity_{p,s} is similarity between the normal vector of the pixel p and a normal vector of an s^{th} plane of the crab aquaculture cage, nₚ is the normal vector of the pixel p, and nₛ is the normal vector of the s^{th} plane of the crab aquaculture cage; and
determining a plane with greatest similarity as the plane to which the pixel p belongs.

7. The machine vision-based method for estimating an inner wall depth of a facility-based crab aquaculture cage according to claim 6, wherein when a camera imaging plane is parallel to the bottom plane of the crab aquaculture cage and a camera optical center is aligned with a geometric center of the bottom plane of the crab aquaculture cage, normal vectors of the front plane, the back plane, the left plane, the right plane, and the bottom plane of the crab aquaculture cage are respectively (0,1,0), (0,−1,0), (−1,0,0), (1,0,0), and (0,0,1).

8. The machine vision-based method for estimating an inner wall depth of a facility-based crab aquaculture cage according to claim 1, wherein respectively determining the inner wall depths at different pixels on each of the five planes based on pixel coordinates of each pixel on each of the five planes and the physical dimensions of the crab aquaculture cage comprises:
constructing plane equations for side surfaces of the crab aquaculture cage based on the physical dimensions of the crab aquaculture cage, wherein the side surfaces of the crab aquaculture cage comprises the front plane, the back plane, the left plane, and the right plane;
performing inverse projection transformation on each pixel to obtain three-dimensional coordinates of each pixel in a world coordinate system;
combining the three-dimensional coordinates of each pixel in the world coordinate system with a plane equation of a side surface to which the pixel belongs, to calculate the inner wall depths at different pixels on the side surfaces; and
determining an inner wall depth of the bottom plane of the crab aquaculture cage based on a distance between the bottom plane of the crab aquaculture cage and the camera imaging plane as follows: depth_{bottom}=height, wherein height is the distance between the bottom plane of the crab aquaculture cage and the camera imaging plane, and depth_{bottom} is the inner wall depth of the bottom plane of the crab aquaculture cage.

9. The machine vision-based method for estimating an inner wall depth of a facility-based crab aquaculture cage according to claim 8, wherein the plane equations for the side surfaces are as follows:
$${P}_{front} : ( {a}_{21} {u}_{front} + {a}_{22} {v}_{front} + {a}_{23} ) Z ( {u}_{front} , {v}_{front} ) + {b}_{2} = \frac{width}{2} .$$
$${P}_{back} : ( {a}_{21} {u}_{back} + {a}_{22} {v}_{back} + {a}_{23} ) Z ( {u}_{back} , {v}_{back} ) + {b}_{2} = - \frac{width}{2} ;$$
$${P}_{left} : ( {a}_{11} {u}_{left} + {a}_{12} {v}_{left} + {a}_{13} ) Z ( {u}_{left} , {v}_{left} ) + {b}_{1} = - \frac{length}{2} ;$$
$${P}_{right} : ( {a}_{11} {u}_{right} + {a}_{12} {v}_{right} + {a}_{13} ) Z ( {u}_{right} , {v}_{right} ) + {b}_{1} = \frac{length}{2} ;$$
wherein, P_{front}, P_{back}, P_{left}, and P_{right} respectively indicate the front plane, the back plane, the left plane, and the right plane; a₁₁, a₁₂, a₁₃, and b₁ are x-axis coordinate transformation coefficients; a₂₁, a₂₂, a₂₃, and b₂ are y-axis coordinate transformation coefficients; u_{front} and v_{front} are respectively horizontal and vertical coordinates of the pixel on the front plane; u_{back} and v_{back} are respectively horizontal and vertical coordinates of the pixel on the back plane; u_{left} and v_{left} are respectively horizontal and vertical coordinates of the pixel on the left plane; u_{right} and v_{right} are respectively horizontal and vertical coordinates of the pixel on the right plane; Z(u_{front}, v_{front}) is a depth estimation value at the pixel coordinates (u_{front}, v_{front}) of the pixel on the front plane; Z(u_{back}, v_{back}) is a depth estimation value at the pixel coordinates (u_{back}, u_{back}) of the pixel on the back plane; Z(u_{left}, v_{left}) is a depth estimation value at the pixel coordinates (u_{left}, v_{left}) of the pixel on the left plane; Z(u_{right}, v_{right}) is a depth estimation value at the pixel coordinates (u_{right}, v_{right}) of the pixel on the right plane; width is an inner width of the crab aquaculture cage; and length is an inner length of the crab aquaculture cage.

10. The machine vision-based method for estimating an inner wall depth of a facility-based crab aquaculture cage according to claim 9, wherein formulas for calculating the inner wall depths at different pixels on the side surfaces are as follows:
$${depth}_{left} ( {u}_{left} , {v}_{left} ) = \frac{- \frac{length}{2} - {b}_{1}}{{a}_{11} {u}_{left} + {a}_{12} {v}_{left} + {a}_{13}} ;$$
$${depth}_{right} ( {u}_{right} , {v}_{right} ) = \frac{\frac{length}{2} - {b}_{1}}{{a}_{11} {u}_{right} + {a}_{12} {v}_{right} + {a}_{13}} ;$$
$${depth}_{front} ( {u}_{front} , {v}_{front} ) = \frac{\frac{width}{2} - {b}_{2}}{{a}_{21} {u}_{front} + {a}_{22} {v}_{front} + {a}_{23}} ; and$$
$${depth}_{back} ( {u}_{back} , {v}_{back} ) = \frac{- \frac{width}{2} - {b}_{2}}{{a}_{21} {u}_{back} + {a}_{22} {v}_{back} + {a}_{23}} .$$
wherein, depth_{left}(u_{left}, v_{left}) is an inner wall depth at the pixel coordinates (u_{left}, v_{left}) of the pixel on the left plane; depth_{right}(u_{right}, v_{right}) is an inner wall depth at the pixel coordinates (u_{right}, v_{right}) of the pixel on the right plane; depth_{front}(u_{front}, v_{front}) is an inner wall depth at the pixel coordinates (u_{front}, v_{front}) of the pixel on the front plane;
and depth_{back}(u_{back}, u_{back}) is an inner wall depth at the pixel coordinates (u_{back}, u_{back}) of the pixel on the back plane.

11. A machine vision-based method for estimating an inner wall depth of a facility-based crab aquaculture cage, comprising:
acquiring a top-view image of the crab aquaculture cage containing crabs and transparent water body;
inputting the top-view image into a monocular depth estimation model, and outputting a depth estimation value of each pixel in the top-view image;
inputting the top-view image into a deep learning based object detection algorithm to determine pixels of a water surface that contact with a front plane, a back plane, a left plane and a right plane of the crab aquaculture cage and excluding other pixels of the transparent water body than the pixels of the water surface that contact with the front plane, the back plane, the left plane and the right plane;
converting pixel coordinates of each pixel of remaining pixels in the top-view image into three-dimensional point cloud data of each pixel based on the depth estimation value of each pixel, wherein the three-dimensional point cloud data of each pixel are three-dimensional coordinates of each pixel in a camera coordinate system;
calculating a normal vector of each pixel based on the three-dimensional point cloud data of each pixel;
determining, based on the normal vector of each pixel, a plane of the crab aquaculture cage to which each pixel belongs, wherein the crab aquaculture cage comprises five planes that are the front plane, the back plane, the left plane, the right plane, and a bottom plane of the crab aquaculture cage;
respectively determining inner wall depths at different pixels on each of the five planes based on pixel coordinates of each pixel on each of the five planes and physical dimensions of the crab aquaculture cage;
inputting the top-view image into the deep learning based object detection algorithm to determine crab pixels corresponding to the crabs;
determining, based on the crab pixels, an inner wall depth of a crab pixel cluster comprising a plurality of crab pixels gathering together, through calculating an average of inner wall depths of the crab pixels gathering together on each of the front plane, the back plane, the left plane and the right plane of the crab aquaculture cage;
determining an average of inner wall depths of the pixels of the water surface that contact with the front plane, the back plane, the left plane and the right plane, as an inner wall depth of a water level line;
calculating a difference value between the inner wall depth of the crab pixel cluster and the inner wall depth of the water level line; and
in response to a determination that the difference value is less than a predetermined threshold, sending a warning signal indicating an abnormal status of the crabs to an external device.
